(19) United States
(12) Patent Application Publication
(10) Pub. No.: US 2026/0287413 A1
(43) Pub. Date: Sep. 24, 2026

(54) RADIOMETRIC DETECTOR

(71) Applicant: Endress+Hauser SE+Co. KG, Maulburg (DE)

(72) Inventors: Gerd Bechtel, Steinen (DE); Viraj Chitale, Steinen (DE); Narcisse Michel Nzitchieu Gadeu, Maulburg (DE); Simon Weidenbruch, Lörrach (DE)

(21) Appl. No.: 19/140,142

(22) PCT Filed: Dec. 7, 2023
(86) PCT No.: PCT/EP2023/084666

§ 371 Date: Jun. 17, 2025

(30) Foreign Application Priority Data
Dec. 19, 2022 (DE) 10 2022 133 804.5

(51) Int. Cl. G01F 25/20; G01F 23/288

(52) U.S. Cl. CPC G01F 25/24; G01F 23/288

(57) ABSTRACT

A detector for radiometric measuring systems includes: a scintillator; and a photo-receiver unit optically connected to the scintillator in order to generate an electric analysis signal on the basis of a radioactive radiation intensity entering the scintillator. An analysis unit can determine the density or the fill level using the analysis signal. The detector further includes a reference photo-receiver unit which is likewise optically connected to the scintillator in order to generate an electric reference signal on the basis of the radioactive radiation intensity entering the scintillator. In this manner, the analysis unit can check whether the analysis signal and the reference signal match. If not, the detector is classified as not being functional. By virtue of the aforementioned redundant design, the detector satisfies corresponding SIL specifications and thus becomes correspondingly more reliable or maintenance-friendly.

The invention relates to a reliable detector for radiometric density or fill level measurement.

In automation technology—in particular in process automation—measuring devices or measuring systems are used to record and/or influence process variables. The process variables determined include the fill level, volume flow, pressure, temperatures, pH value, redox potential or conductivity. Depending on the process variable, different measuring principles are implemented in the measuring device or measuring system each time. Actuators, such as valves or pumps among other things, by means of which the flow rate of a liquid in a pipeline portion or the fill level in a container can be altered, are used to influence process variables. A plurality of such measuring devices are manufactured and sold by the Endress +Hauser group.

Measuring systems based on radiometry are in particular used for fill level measurement in applications where other measuring principles, such as radar, fail due to harsh operating conditions. According to the radiometric measuring principle, radioactive radiation (for example gamma radiation of a cesium or cobalt source) is used, which is emitted by a radioactive radiation source of the measuring device and is guided through the container containing the relevant contents. After passing through the container, the transmitted radiation intensity is recorded by a detector of the measuring device. For this purpose, the detector is arranged on the container so as to be approximately opposite the radiation source. By determining the intensity or power of the signal entering at the detector, the transmitted portion of the radiation emitted by the detector is determined. This is used to deduce the fill level of the contents in the container. The transmitted portion of the radioactive radiated power cannot be directly detected after it has passed through the container. For this purpose, the radioactive radiation in the detector must first be converted into electromagnetic radiation in the optical spectral range by a suitable material. Only then can the radiated power within the detector be detected by a photo-receiver unit. For this purpose, the photo-receiver unit and the reference photo-receiver unit can comprise, for example, one or more photomultipliers and/or photodiodes, such as an avalanche photodiode or a silicon photomultiplier. Materials that convert radiometric rays into optical radiation are called scintillating materials. Polystyrene, polyvinyl toluene and thallium-doped sodium iodide, among others, each exhibit this scintillating property. Radiometric fill level or density measuring systems are already known from the prior art. The basic operating principle is described in the patent specification EP 2 208 031 B1 , for example.

Regardless of the measurement principle implemented, safety-relevant measuring systems require that the different functional units of the device be able to be monitored such that any malfunctioning of each of the units can be detected with a sufficient degree of safety. Corresponding safety specifications are defined, for example, as “Safety Integrity Level x (SILx)” according to the IEC61508 standard series. If the measuring system cannot comply with such safety specifications or can only comply with some of them, it is considered to be unsafe and may be operated only with appropriately shorter test cycles, if at all. However, such test cycles are complex and, accordingly, undesirable in an ongoing production process. However, it is difficult to check the correct function of the photo-receiver unit because failures in said unit may not be clearly identified as defects. The object of the invention is therefore that of providing an improved radiometric measuring system in this regard.

The invention solves this problem by means of a detector for a radiometric measuring system which determines the density and/or fill level of contents in a container, comprising the following components:
a scintillator,
a photo-receiver unit which is optically connected to the scintillator so as to generate an electrical analysis signal on the basis of a radioactive radiation intensity entering the scintillator, and
a reference photo-receiver unit, which is in particular not identical to the photo-receiver unit and is optically connected to the scintillator so as to generate an electrical reference signal on the basis of the radioactive radiation intensity entering the scintillator, and
an analysis unit, which is designed
   to check whether the analysis signal and the reference signal match, and
   to determine the density and/or the fill level of the contents at least on the basis of the analysis signal or on the basis of the reference signal,
   to classify the detector as not being functional if the analysis signal and the reference signal do not match.

If the analysis unit digitizes the analysis signal and the reference signal, it is of course conceivable for the analysis unit to check that the already digitized signals match.

Due to the redundant design according to the invention of the detector comprising an additional reference photo-receiver unit, the analysis unit can, when appropriately designed, generate an SIL-compliant error signal if the analysis unit classifies the detector as not being functional or if the analysis signal and the reference signal do not match. Overall, this thus makes the detector more reliable and easier to maintain in terms of test cycles.

If the analysis unit is designed to determine the density or fill level on the basis of both the analysis signal and the reference signal, the measured value can also be determined with greater accuracy by means of the detector according to the invention. The invention can be implemented independently of the realization of the photo receiver. For example, the photo-receiver unit and the reference photo-receiver unit of the detector can each be based on one or more photomultipliers, or on photodiodes, such as an array of avalanche photodiodes or an array of silicon photomultipliers. From a safety point of view, it is advantageous not to design the reference photo-receiver unit of the detector according to the invention to be identical to its photo-receiver unit in order to reduce the risk of both photo-receiver units being subject to a type-related failure mechanism. For this purpose, the reference photo-receiver unit can be designed, for example, as a GaAs-based avalanche photodiode, while the actual photo-receiver unit is designed as a silicon photomultiplier.

It is not absolutely necessary for the photo-receiver unit and the reference photo-receiver unit to optically be coupled to the same first end region of the scintillator. In principle, it is also conceivable that the first photo-receiver unit is optically coupled to the first end region of the scintillator, while the reference photo-receiver unit is optically coupled to a second opposite end region of the scintillator. In this case, however, in order to achieve signal coherence, it may be necessary for the analysis unit to comprise a signal delay component used to temporally delay the analysis signal and/or the reference signal. In the case of digitized signals, this can be, for example, a shift register.

A corresponding radiometric measuring device, which is used for measuring the density or fill level of contents in containers, comprises, in addition to the detector according to the invention, a radioactive radiation source, which can be mounted with respect to the container in such a way that radioactive radiation is emitted toward the container within a defined beam cone. In this case, the detector must be mounted on the container so as to be opposite the radiation source such that the scintillator is at least partially located in the beam cone.

In the context of the invention, the term “unit” is understood in principle to mean any electronic circuits that are provided for a specific application-for example, for processing measured signals or as an interface. Depending upon the application, each unit may therefore comprise corresponding analog circuits for generating or processing analog signals. However, the unit can also comprise digital circuits, such as FPGAs, microcontrollers, or storage media in conjunction with appropriate programs. The program is designed to carry out the required method steps or to apply the necessary computing operations. In this context, different units within the sense of the invention can potentially also access a common physical memory or be operated by means of the same physical digital circuit. In this case, it does not matter whether different electronic circuits within a unit are arranged on a common printed circuit board or on a plurality of interconnected printed circuit boards.

The invention is explained in more detail with reference to the following figure. in which:

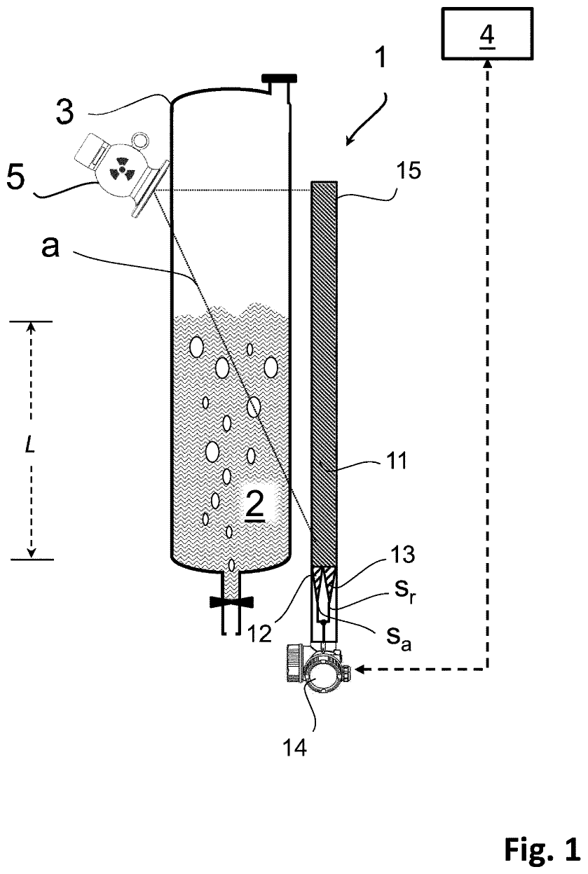

FIG. 1: shows a radiometric measuring system on a container.

To understand the invention, FIG. 1 shows a radiometric measuring system intended for industrial fill level measurement, which is based on a detector 1 as per the invention.

Accordingly, FIG. 1 shows a container 3 of an industrial process plant. The container 3 can contain, for example, crude oil as the contents 2, which undergoes a re-fractionation process therein. To control the process, the fill level L and/or a density profile of the contents 2 must be determined, wherein the radiometric measuring principle is used due to the harsh process conditions. For this purpose, a radioactive radiation source 5 of the measuring system is arranged and aligned on the container 3 in such a way that radioactive radiation is emitted toward container 3 within a defined beam cone a. In the variant shown in FIG. 1, the radiation source 5 is arranged in an upper end region of the container 3 and is inclined downward by approximately 45°. This ensures that the beam cone a radiates through the measuring region I of the container interior that is essential for measuring the fill level or density profile. Depending on the height of the container 3 or the process in progress, the height of this measuring region I can differ, which is why the measuring system must in principle be individually adaptable thereto.

The detector 1 is arranged opposite the radiation source 5 on the container 3 so as to be in the beam cone a of the radiation source 5.

In each case, the detector 1 comprises all of the components required by the functional principle to generate an electrical analysis signal sₐ on the basis of incident radioactive radiation, which signal represents the power or intensity of the incident radiation: A scintillator 11 of the detector 1 serves to convert the radioactive radiation arriving from the radiation source 5 into optical radiation or radiation that is adjacent thereto in the spectrum. For this purpose, the scintillator 11 can be based on organic scintillator materials, such as polystyrene or polyvinyl toluene. Conversely, crystalline or inorganic materials can be used that have correspondingly scintillating properties, such as thallium-doped sodium iodide or gadolinium-aluminum-gallium garnet.

The radiation converted into optical radiation by the scintillator 11 is then converted by a photo-receiver unit 12 into an analysis signal sₐ which thereby represents the power or intensity of the radiation entering the scintillator 11. The photo-receiver unit 12 can be realized as a photomultiplier or as a photodiode, such as a GaAs-based avalanche photodiode or a so-called silicon photomultiplier. In the exemplary embodiment shown, the photo-receiver unit 12 is arranged in a lower end region of the scintillator 11 for this purpose.

Due to the-vertical-alignment of the scintillator 11 toward the beam cone a of the radiation source 5, the scintillator 11 receives the radioactive radiation after it has passed through the contents 2 or through the gas phase located thereabove in the container interior. Thus, the intensity of the received radiation-in relation to the initial intensity at the radiation source 5-depends substantially on the fill level L of the contents 1 and on its density: If, depending on the fill level L, contents 2 is located in the beam path between the radiation source 5 and the scintillator 11, the intensity of the incident radioactive radiation accordingly decreases significantly or measurably. As a result, the analysis signal sₐ from the photo-receiver unit 12 represents the radiation intensity entering the scintillator 11, provided that the photo-receiver unit 12 is fully functional.

To determine the density or the fill level L on the basis of the analysis signal sₐ, a correspondingly designed analysis unit 14 of detector 1 is used. As shown in FIG. 1, the photo-receiver unit 12 and the analysis unit 14 correspondingly electrically contact one another for this purpose. At the same time, the power supply to the photoreceiver unit 12 is ensured by the analysis unit 14 via this contact.

On the whole, the radiation source 5 and the detector unit 1 can either be mounted directly on the container 3, or indirectly on correspondingly free-standing stands. As shown in FIG. 1, in order to control the process using closed-loop control, the analysis unit 14 of the measuring system can also be connected to a master unit 4, such as a local process control system or a decentralized server system, via a separate interface unit, such as “4-20 mA”, “PROFIBUS”, “HART”, or “Ethernet”. The measured density or fill level value L can be transmitted thereby, for example to control heating elements or any supply lines on the container 3 using open-loop control. However, other information about the general operating state of the measuring system 1 can also be communicated. If the functional scope of the analysis unit 14 is limited to the 1 transmission of the analysis signal sₐ to the master unit and the power supply to the 2 photo receiver unit 12 is limited, the master unit 4 can in this case also determine the measured density or fill level value L on the basis of the analysis signal sₐ.

Various mechanisms during operation, such as aging or mechanical vibrations, can lead to the analysis unit 14 or the master unit 4 determining an incorrect measured fill level or density value, which can lead to incorrect closed-loop control of the process taking place in the container 3. It is not obvious from the outside that the measured value determined is incorrect or that detector 1 is not functional.

To prevent this, in addition to the actual photo-receiver unit 12, the detector 1 according to the invention additionally comprises a reference photo-receiver unit 13, which in turn is optically coupled to the scintillator 11. In the variant shown, the reference photo-receiver unit 13 is not identical to the photo-receiver unit 12. This means that the reference photo-receiver unit 13 can be designed, for example, as a photomultiplier, while the actual photo-receiver unit 12 is designed, for example, on the basis of GaAs-based avalanche photodiodes.

In the variant shown in FIG. 1, the reference photo-receiver unit 13 is arranged in the same lower end region of the scintillator 11 as the actual photo-receiver unit 12. Such a design advantageously ensures that these signals sₐ, sᵣ from the photo-receiver units 12, 13 do not have different delay times. In contrast, it is also possible within the scope of the invention that the reference photo-receiver unit 13, in contrast to the photo-receiver unit 12, is actually arranged in the upper end region of the scintillator. This design offers the advantage that, on the whole, higher radiant power can be received due to the potentially larger area of contact with the scintillator 11. This in turn increases the measurement resolution in principle.

Similarly to the analysis signal sₐ from the photo-receiver unit 12, the reference photo-receiver unit 13 generates an electrical reference signal sr which also represents the radioactive radiation intensity entering the scintillator 11 provided that the reference photo-receiver unit 13 is fully functional. According to the invention, this can be used to check whether the analysis signal sₐ and the reference signal sᵣ match within a permitted or previously defined tolerance. This test can be carried out by the analysis unit 14. Alternatively, however, this test can also be carried out by the master unit 4 provided that the analysis unit 14 is only used for digitizing and/or transmitting the signals sₐ, sᵣ to the master unit 4.

If the check shows that the analysis signal sₐ and the reference signal sr match, the measured density or fill level value determined on the basis of the analysis signal sₐ or the reference signal sᵣ can be considered to be valid. In the event that the measured density or fill level value is determined in the analysis unit 14, said unit can, if necessary, generate a corresponding error signal in addition to the measured value or transmit said error signal to the master unit 4 if the detector 1 has been classified as not being functional or if the analysis signal sₐ and the reference signal sr do not match.

Through this redundant design and the comparison of the signals sₐ, sᵣ, the detector 1 fulfills corresponding SIL specifications and is therefore more reliable and easier to maintain. In addition, the redundant design also has the advantage that the measured fill level or density value can be determined with greater accuracy provided that it is determined on the basis of both the analysis signal sₐ as well as the reference signal sᵣ, since in this case the analysis unit 14 on the whole has a higher signal strength available for analysis and the signal-to-noise ratio is significantly increased.

In the variant of the detector 1 according to the invention shown in FIG. 1, the analysis unit 14 is structurally arranged in a separate housing part. This housing part in turn connects to the lower end region of a housing 15 in which the scintillator 11 and the photo-receiver unit 12 are arranged. In contrast to the illustration shown, it is also conceivable that the housing part of the analysis unit 14 connects to the upper end region of the housing 15. Furthermore, in contrast to the illustration in FIG. 1, it is conceivable that the analysis unit 14 is arranged in the same housing 14 as the scintillator 11 and the photoreceiver unit 12. For interference-free measurement, it is essential that the housing 15 is opaque to protect the photo-receiver units 12, 13 from extraneous light and corresponding falsification of the measured values.

### LIST OF REFERENCE SIGNS

1 Detector
2 Contents
3 Container
4 Master unit
5 Radioactive radiation source
11 Scintillator
12 Photo-receiver unit
13 Reference photo-receiver unit
14 Analysis unit
15 Housing
a Beam cone
L Fill level
sₐ Analysis signal
sᵣ Reference signal

1-9. (canceled)

10. A detector for a radiometric measuring system for determining a density and/or fill level of contents in a container, the detector comprising:
a scintillator;
a photo-receiver unit optically connected to the scintillator and configured to generate an electrical analysis signal based on a radioactive radiation intensity entering the scintillator;
a reference photo-receiver unit optically connected to the scintillator and configured to generate an electrical reference signal based on the radioactive radiation intensity entering the scintillator; and
an analysis unit configured to:
determine the density and/or fill level of the contents at least based on the analysis signal or based on the reference signal,
check whether the analysis signal and the reference signal match, and
classify the detector as not being functional when the analysis signal and the reference signal do not match.

11. The detector according to claim 10, wherein the analysis unit is configured to determine the density and/or fill level based on the analysis signal and based on the reference signal.

12. The detector according to claim 10, wherein the photo-receiver unit and the reference photo-receiver unit are optically coupled to a first end region of the scintillator.

13. The detector according to claim 12, wherein the photo-receiver unit is optically coupled to the first end region of the scintillator and wherein the reference photo-receiver unit is optically coupled to a second end region of the scintillator opposite the first end region.

14. The detector according to claim 10, wherein the analysis unit is configured to digitize the analysis signal and the reference signal, and wherein the analysis unit checks whether the digitized analysis signal and reference signal match.

15. The detector according to claim 10, wherein the photo-receiver unit and the reference photo-receiver unit comprise at least one photomultiplier and/or at least one photodiode.

16. The detector according to claim 10, wherein the photo-receiver unit and the reference photo-receiver unit are not identical types.

17. The detector according to claim 10, wherein the analysis unit is configured to generate an error signal when the analysis unit classifies the detector as not being functional or when the analysis signal and the reference signal do not match.

18. A radiometric measuring system for determining the fill level of contents in a container, comprising:
a radioactive radiation source arrangeable relative to the container such that radioactive radiation is transmitted within a beam cone toward the container, and
the detector according to claim 10, which can be arranged relative to the container opposite the radiation source such that the scintillator is at least partially located in the beam cone of the radiation source.

19. The detector according to claim 15, wherein the photo-receiver unit and the reference photo-receiver unit comprise at least one avalanche photodiode or at least one silicon photomultiplier.
